(19) United States
(12) Patent Application Publication
(10) Pub. No.: US 2008/0096509 A1
(43) Pub. Date: Apr. 24, 2008

(54) Low Complexity Diversity Receiver

(75) Inventor: Curtis Ling, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MaxLinear, Inc., Carlsbad, CA (US)

(21) Appl. No.: 11/874,854

(22) Filed: Oct. 18, 2007

Related U.S. Application Data
(60) Provisional application No. 60/862,193, filed on Oct. 19, 2006.

(51) Int. Cl. H04B 1/06

(52) U.S. Cl. 455/273

(57) ABSTRACT

A diversity receiver and methods of diversity combining are described herein. Diversity combining can be implemented in the front-end signal path of a receiver, without the need to digitally demodulate the baseband signals. Each diversity path is downconverted using a common LO. A portion of each downconverted diversity path is filtered and coupled to an input of a correlator. The diversity paths are paired for the purposes of correlation. The output of the correlator is used to adjust the phase of one of the diversity paths. The amplitude of each diversity path can be equalized or can be adjusted based on a signal metric. The phase adjusted diversity signals can be summed in a signal combiner. The summed signal can be processed as a single receive signal using a single filter and baseband processor.

### CROSS-REFERENCES TO RELATED APPLICATIONS

This application claims the benefit of U.S. Provisional Application No. 60/862,193, filed Oct. 19, 2006, and entitled “LOW COMPLEXITY ANTENNA DIVERSITY,” hereby incorporated by reference herein in its entirety.

### BACKGROUND

1. Field of the Invention

The invention described herein is related to wireless communications. In particular, the disclosure relates to methods and apparatus for implementing antenna diversity using relatively simple analog front-end circuits, instead of using backend digital signal processing. The methods and apparatus are applicable to all diversity receivers, especially for TV applications, which require one receiver path per diversity branch.

2. Description of Related Art

Mobile communications systems experience significant performance enhancement when they utilize antenna diversity, which mitigates the effects of a fading environment.

One manner of achieving a diversity gain is to include a distinct receiver, including a distinct processing path, for each diversity path. Each processing path is configured to operate on a distinct signal path to recover a distinct version of the received signal. The distinct versions of the desired received signal can be summed or otherwise combined to provide diversity gain. However, the amount of resources needed to implement this diversity receiver configuration is substantially equal to the amount of resources needed to duplicate N receivers, where N represents the number of diversity paths.

A low-cost low-power solution would particularly benefit handset and mobile terminal applications.

### BRIEF SUMMARY

Diversity combining can be implemented in an analog portion of a receiver, without the need to perform digital processing of baseband signals. Each diversity path is downconverted using a common LO. A portion of each downconverted diversity path is filtered and coupled to an input of a correlator. The diversity paths are paired for the purposes of correlation. The output of the correlator is used to adjust the phase of one of the diversity paths so that the correlation is maximized; this is commonly referred to as “cophasing” and is also utilized in maximum ratio combining (MRC). The amplitude of each diversity path can be equalized or can be adjusted based on a signal metric (as in MRC). The phase and amplitude adjusted diversity signals can be summed in a signal combiner. The summed signal can be processed as a single receive signal using a single filter and baseband processor.

Aspects of the invention include a method of combining signals in a diversity receiver. The method includes receiving an RF signal in each of a plurality of diversity signal paths sharing synchronized Local Oscillator (LO) sources or a single LO source, frequency converting each of the RF signals to a corresponding frequency converted diversity signal, correlating a first frequency converted diversity signal with at least one distinct frequency converted diversity signal to generate a correlation value, adjusting a phase of the first frequency converted diversity signal based on the correlation value in order to cophase the signals or use MRC, and combining the frequency converted diversity signals prior to demodulation.

Aspects of the invention include a method of combining signals in a diversity receiver. The method includes receiving a first RF signal, frequency converting the first RF signal to a first diversity signal, receiving a second RF signal, frequency converting the second RF signal to a second diversity signal, phase shifting the second diversity signal to generate a phase shifted diversity signal, correlating the first diversity signal with the phase shifted diversity signal to determine a correlation value, adjusting a phase shift of the phase shifted diversity signal based on the correlation value, and summing the first diversity signal with the phase shifted diversity signal to generate a combined signal. The diversity signals and the signal processing discussed here can be implemented in the analog or digital domain depending on the application.

Aspects of the invention include a diversity receiver that includes a first RF front end configured to receive a first RF signal and frequency convert the first RF signal and output a first diversity signal, a second RF front end configured to receive a second RF signal and frequency convert the second RF signal and output a second diversity signal, a variable phase shifter coupled to the second RF front end and configured to selectively phase shift the second diversity signal to generate a phase shifted second diversity signal based on a value at a control input, a correlator having a first input coupled to the first RF front end, a second input coupled to an output of the variable phase shifter, and configured to determine a correlation value based at least in part on the first diversity signal and the phase shifted second diversity signal and couple the correlation value to the control input of the variable phase shifter, and a combiner coupled to the first RF front end and the variable phase shifter and configured to combine the first diversity signal with the phase shifted second diversity signal.

Aspects of the invention include a diversity receiver that includes means for receiving an RF signal in each of a plurality of diversity signal paths, means for frequency converting each of the RF signals to a corresponding frequency converted diversity signal, means for correlating a pair of frequency converted diversity signals to generate a correlation value, means for adjusting a phase of one of the pair of frequency converted diversity signals based on the correlation value, and means for combining the frequency converted diversity signals.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a simplified functional block diagram of a conventional diversity receiver requiring full signal paths for each diversity branch.

FIGS. 2A-2B are simplified functional block diagrams of embodiments of diversity receivers.

FIGS. 3A-3B are simplified functional block diagrams of embodiments of a diversity combining front end which reuses front-end hardware while performing parameter estimation and signal combining the analog domain.

FIG. 4 is a simplified timing diagram of an embodiment of a time division multiple access timing and utilizing time-sliced protocols to improve estimation of phase shifter settings.

FIG. 5 is a simplified flowchart of an embodiment of a method of diversity combining in a receiver.

### DETAILED DESCRIPTION OF EMBODIMENTS OF THE INVENTION

A diversity receiver and methods of diversity combining in a receiver are described herein. Each diversity signal path in a diversity receiver can correspond to a distinct antenna. In an embodiment of a diversity receiver, each RF signal from a distinct antenna can be frequency translated to another frequency, such as an Intermediate Frequency (IF) or baseband frequency. Each frequency translated diversity signal can be adjusted by a fixed or variable phase delay. The delayed diversity signals are coupled to inputs of one or more correlators. In one embodiment, the delayed diversity signals are organized as diversity signal pairs, and each diversity signal pair is coupled to inputs of a correlator.

The correlator can be configured to determine a correlation of the signals in the diversity signal pair and can output a correlation value representative of the correlation. The correlation value can be used to control a variable phase delay associated with one of the diversity signals in the diversity signal pair. The correlator and variable phase delay can be configured to converge on a phase delay that results in a maximum correlation.

The delayed diversity signals can be combined or otherwise summed to generate a combined signal. The signal quality of the combined signal can benefit from diversity combining that is optimized through operation of the various correlation control loops.

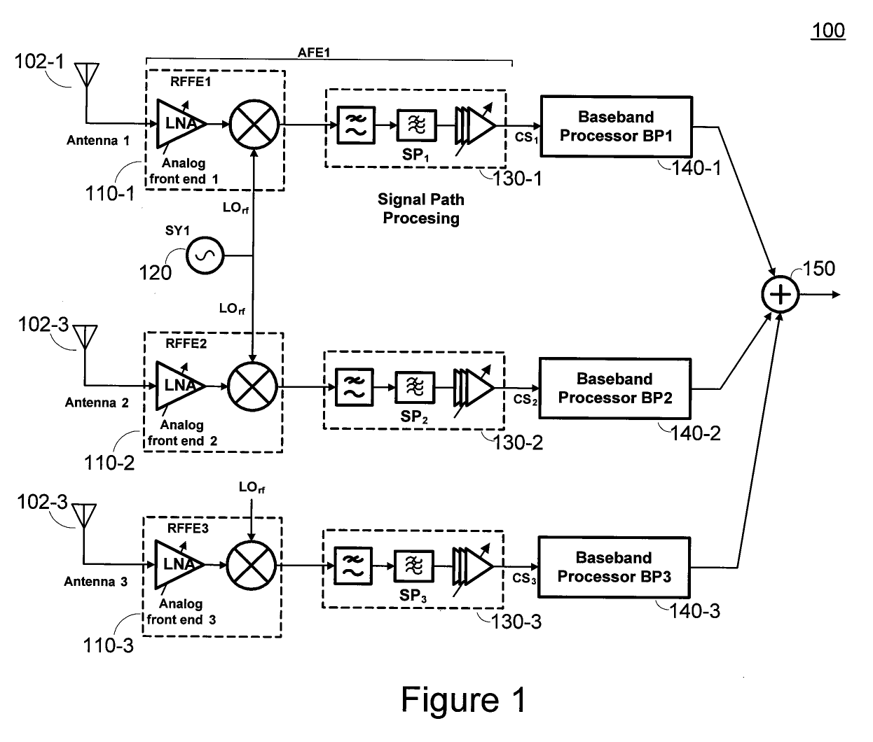

FIG. 1 is a simplified functional block diagram of a conventional diversity receiver 100 requiring full signal paths for each diversity branch. This diversity receiver 100 embodiment requires replicating the hardware once for each branch of diversity. Conventional antenna diversity systems typically use one receiver path, RFEᵢ (subscript indexes diversity branch), for each antenna present in the system.

In a three-antenna 102-1, 102-2, and 102-3 diversity receiver, for example, the diversity receiver 100 includes three receiver front end modules 110-1, 110-2, and 110-3 feeding the baseband processors 140-1, 140-2, and 140-3, respectively. In each receiver path, the signal enters an RF front end 110, where the signal is amplified, filtered and downconverted prior to being further processed and digitized as a baseband signal. A common local oscillator 120 can be coupled to each of the RF front end modules 110 to frequency convert the various RF diversity signals to corresponding baseband signals.

A signal processing module 130 in each diversity receiver path can be configured to filter and amplify the downconverted signals from the associated RF front end 110. For example, the first RF front end 110-1 couples the frequency converted baseband signal to a first signal processing module 130-1. A second RF front end 110-2 couples the frequency converted baseband signal to a second signal processing module 130-1, and a third RF front end 110-3 couples the frequency converted baseband signal to a third signal processing module 130-3.

A baseband processor 140 in each receiver path processes the respective baseband signals from the signal processing module 130 to recover the underlying component signals. Each of the first, second, and third signal processing modules, 130-1, 130-2, and 130-3, couples the filtered and amplified baseband signal to a corresponding baseband processor 140-1, 140-2, and 140-3, respectively.

Each of the baseband processors 140-1, 140-2, and 140-3 can be configured to demodulate and further process the baseband signals, and can be configured to time align the signals in the various signal paths to permit coherent combining.

The diversity receiver 100 combines the baseband signals from each receiver path (the “component signals”) using a combiner 150 that is configured in such a way as to optimize “signal quality” using various algorithms ranging from simple switched diversity, to optimal combining where the signals from each diversity branch are co-phased and summed, to interference cancellation, where the signals are combined in such a way as to reduce co-channel interference (CCI) which is a significant degrader of the signal quality of the desired signal.

An advantage of this approach is that it allows the component signals to be individually equalized. That is, a frequency-dependent phase and amplitude can be applied across the frequency components of each diversity signal prior to combining. However, the cost of the approach is that it requires full receiver and baseband signal paths for each antenna in the diversity system.

As an alternative, the combination of diversity paths can be performed in the analog domain, prior to digital signal processing of the baseband signals. In this embodiment, the diversity receiver performs signal combining and parameter estimation in the analog front end circuits, instead of performing the same tasks in the digital baseband. By doing so, it eliminates duplication of baseband signal processors while permitting the diversity branches to share common circuit blocks. This results in considerable hardware (size and cost) and power savings.

It is possible to combine diversity antenna signals using front-end analog circuits to achieve significant diversity gain in comparison to the previously described diversity techniques where the signal path is essentially duplicated. One approach is described in U.S. Pat. No. 6,172,970 to Ling et al., hereby incorporated by reference herein in its entirety.

Providing diversity gain through combination in the front end signal path, prior to demodulation, provides significant hardware savings by eliminating duplicate baseband signal processing paths and, since each antenna is receiving the same desired channel, local oscillator, channel selection filters, amplifiers and data conversion hardware can be shared as desired.

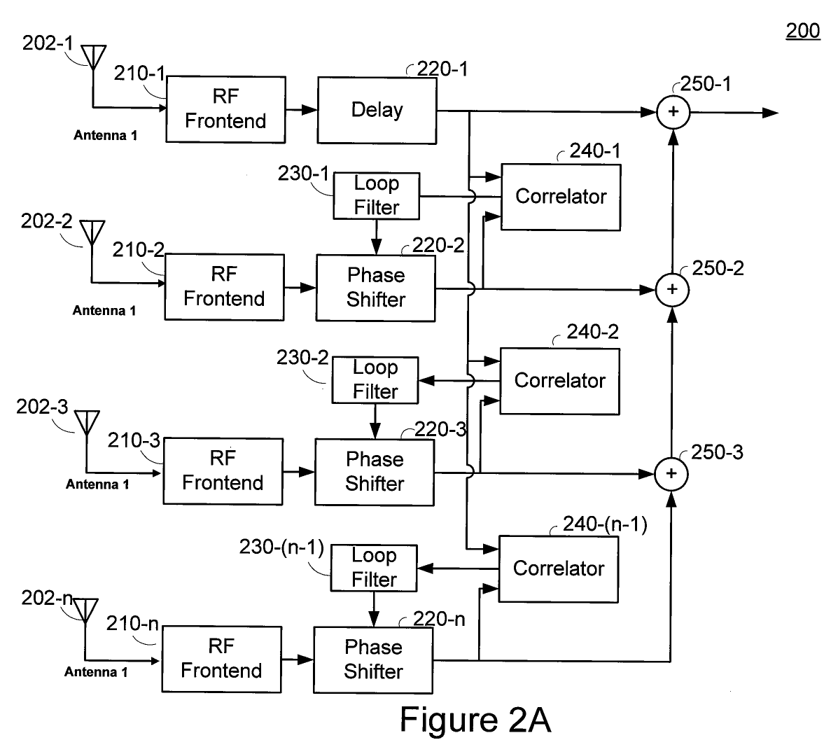

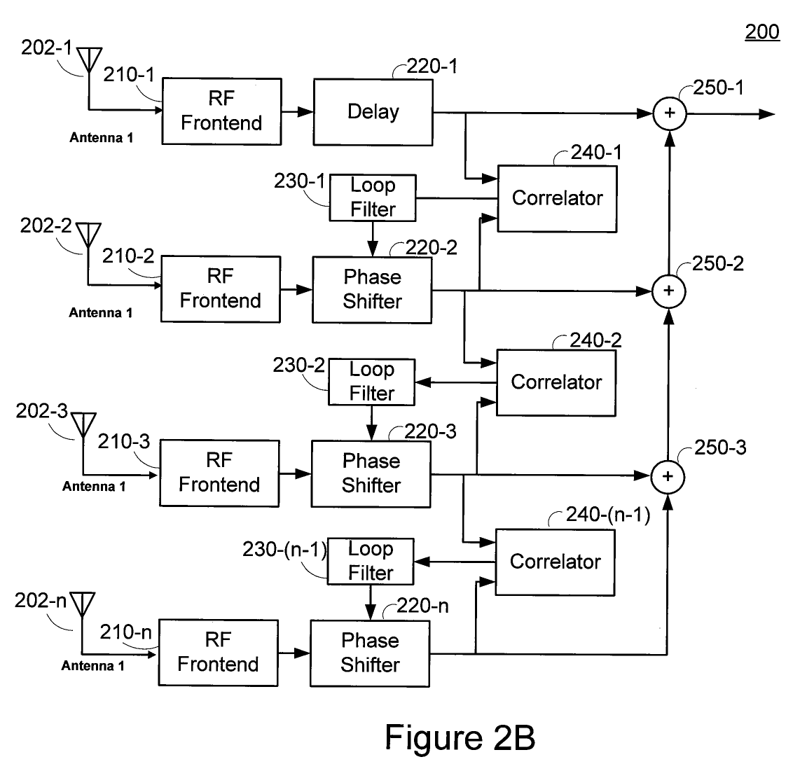

FIGS. 2A-2B are simplified functional block diagrams of embodiments of diversity receivers 200 implementing diversity combining in the analog domain prior to baseband processing. Although the diversity receiver 200 embodiments are described as being implemented within the analog signal processing paths, the diversity receiver is not limited to an analog implementation. Some or all of the signal processing may also be performed following analog to digital conversion. However, the diversity receiver 200 embodiments permit diversity combining of signals without the need to demodulate any of the receive signal paths.

In the embodiment of FIG. 2A, a first diversity path serves as a reference path to process a first diversity signal. The first diversity signal represents a reference signal against which signals from each of the additional diversity paths is correlated. The embodiment of FIG. 2B is virtually identical to the embodiment of FIG. 2A, except for the manner in which the diversity signals are paired and correlated.

In the embodiment of FIG. 2B, the diversity paths are correlated in pairs, and no single diversity path generates a reference signal for each of the signal paths. The second embodiment may be advantageous in the situation where the first diversity path may be subject to a deep signal fade, and thus may not have sufficient signal quality to serve as a reference signal.

The diversity receiver 200 embodiments and methods described herein are not limited to processing any particular type of received RF signal, but may be applicable to any type of modulated signal that may benefit from diversity combining. For example, the RF signal may be a modulated sinusoid and may be frequency, phase, or amplitude modulated, or a combination of modulation types. Additionally, the RF signal received by the diversity receiver 200 may be spread spectrum signals or orthogonal frequency division multiplex (OFDM) or orthogonal frequency division multiple access (OFDMA) signals. Where the received signals comprise multiple television channels, the received RF signal can be, for example, a Vestigial Side Band (VSB) analog modulated signal or an OFDMA digital modulated signal.

The diversity receiver 200 embodiment of FIG. 2A includes a plurality, N, of diversity signal paths. Each diversity signal path includes an antenna 202 coupled to an RF front end 210 that can be configured to frequency convert the received RF diversity signal, for example, to an Intermediate Frequency signal, or to substantially a baseband signal.

The output from each RF front end 210 is coupled to a phase shifter 220, which may be a fixed phase shifter or a variable phase shifter depending on the diversity path. A first or reference path utilizes a fixed phase shifter, which may be a fixed delay module 220-1. All other diversity paths may be configured with a variable phase delay module 220-2, 220-3, 220-n.

The output from each phase shifter 220 is coupled to a combiner 250 that can be configured to sum the diversity signals or otherwise combine or select the signals. The output from each phase shifter 220 is also coupled to a correlator 240. The output from the fixed delay module 220-1 serves as a reference path and is coupled to inputs of all the correlators 240.

Each correlator 240 correlates its two input signals and generates a correlation value. The correlator couples the correlation value to a loop filter 230 that couples the correlation value to an associated phase shifter 220. The various functions, including the phase shifter 220, loop filter 230, correlator 240 and combiner 250 can be implemented either in the analog or digital domain.

In the example of FIG. 2A, a first antenna 202-1 is coupled to a first RF front end 210-1. The output of the first RF front end 210-1 is coupled to the fixed delay 220-1. The fixed delay 220-1 can also be configured as a filter, a phase shifter, a rotator, or some combination thereof. The output of the fixed delay 220-1 is coupled to a first combiner 250-1 as well as a first input of each of the correlators 240-1, 240-2, 240-(n-1).

A second antenna 202-2 is coupled to a second RF front end 210-2. The output of the second RF front end 210-2 is coupled to a second phase shifter 220-2. The output of the second phase shifter 220-2 is coupled to a second input of the first correlator 240-1. The first correlator 240-1 correlates the second phase shifted diversity signal with the first diversity signal and generates a first correlation value.

The first correlation value is coupled to a first loop filter 230-1 and from the first loop filter 230-1 to the control input of the second phase shifter 220-2.

Similarly, a third antenna 202-3 is coupled to a third RF front end 210-3. The output of the third RF front end 210-3 is coupled to a third phase shifter 220-3. The output of the third phase shifter 220-3 is coupled to a second input of the second correlator 240-2. The second correlator 240-2 correlates the third phase shifted diversity signal with the first diversity signal and generates a second correlation value. The second correlation value is coupled to a second loop filter 230-2 and from the second loop filter 230-2 to the control input of the third phase shifter 220-3.

Likewise, an nth antenna 202-n is coupled to a nth RF front end 210-n. The output of the nth RF front end 210-n is coupled to an nth phase shifter 220-n. The output of the nth phase shifter 220-n is coupled to a second input of the (n-1) correlator 240-(n-1). The n-1 correlator 240-(n-1) correlates the nth phase shifted diversity signal with the first diversity signal and generates a (n-1) correlation value. The (n-1) correlation value is coupled to a (n-1) loop filter 230-(n-1) and from the (n-1) loop filter 230-(n-1) to the control input of the nth phase shifter 220-n.

The diversity receiver 200 of FIG. 2B is similar to that of FIG. 2A, except for the pairing of the diversity paths for correlation. Instead of configuring a first diversity path as a reference path, as is done in the embodiment of FIG. 2A, each diversity path in the diversity receiver 200 embodiment of FIG. 2B is paired with an adjacent diversity path. The diversity paths are paired and correlated to each other, with just one diversity path correlated to a first diversity path.

The connection of the antennas, 202, RF front ends 210, phase shifters 220, and combiners 250 for the embodiment of FIG. 2B is the same as the embodiment of FIG. 2A, and is not repeated here for the sake of brevity. The diversity path pairing and correlations in the diversity receiver 200 embodiment of FIG. 2B do not rely on any particular diversity path.

The first and second diversity paths are paired, as are the third and nth diversity paths. The output from the first phase shifter 220-1 is coupled to the first input of the first correlator 240-1. The output from the second phase shifter 220-2 is coupled to the second input of the first correlator 240-1. The output from the first correlator 240-1 is coupled to a first loop filter 230-1 and then to the control input of the second phase shifter 220-2.

The output from the second phase shifter 220-3 is also coupled to the first input of the second correlator 240-2. The output from the third phase shifter 220-3 is coupled to the second input of the second correlator 240-2. The output from the second correlator 240-2 is coupled to a second loop filter 230-2 and then to the control input of the third phase shifter 220-3.

Similarly, the output from the third phase shifter 220-3 is also coupled to the first input of the (n-1) correlator 240-(n-1). The output from the nth phase shifter 220-n is coupled to the second input of the (n-1) correlator 240-(n-1). The output from the (n-1) correlator 240-(n-1) is coupled to an (n-1) loop filter 230-(n-1) and then to the control input of the nth phase shifter 220-n.

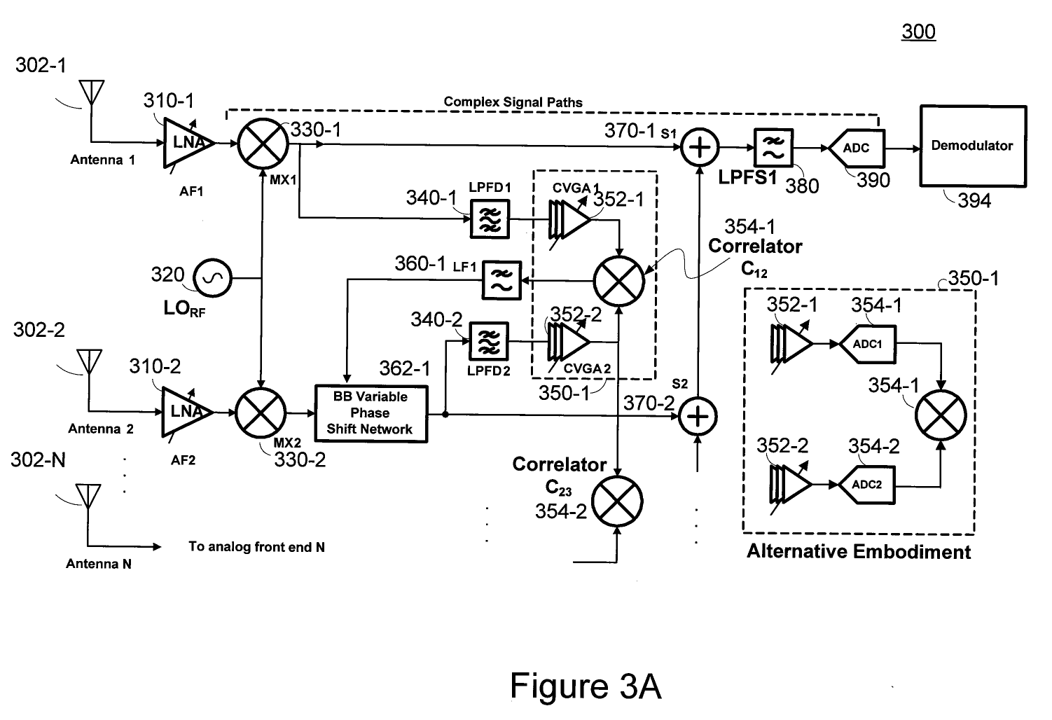

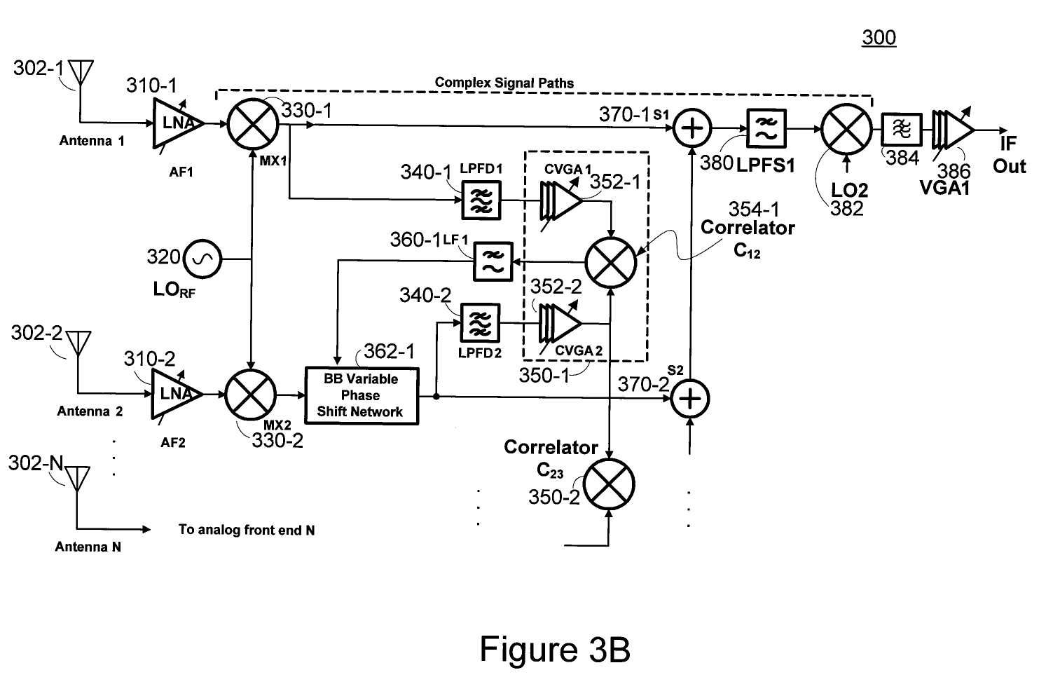

FIG. 3A is a simplified functional block diagram of an embodiment of a diversity receiver 300. The diversity receiver 300 includes a first antenna 302-1 coupled to a first Low Noise Amplifier (LNA) 310-1 that may be configured to have variable gain. The output of the first LNA 310-1 is coupled to an input of a first frequency translation module, here depicted as a first mixer 330-1. The first mixer 330-1 receives a Local Oscillator (LO) signal from a common LO 320 that can be used for all of the diversity paths. The LO 320 can be, for example, a quadrature LO having I and Q LO signals to enable the diversity paths to generate complex signals having quadrature I and Q signal paths.

The frequency converted diversity signal can be, for example, a baseband signal or can be substantially a baseband signal. The first mixer 330-1 couples the first diversity signal to a first combiner 370-1 as well as to a first filter 340-1. The first filter 340-1 operates to filter the first diversity signal and couples the filtered first diversity signal to a first input of the first correlator 350-1. As will be described in further detail below, the first filter can be configured with a passband that is narrower than a desired bandwidth of the first diversity signal.

A second antenna 302-2 is coupled to a second LNA 310-2. The output of the second LNA 310-2 is coupled to a second mixer 330-2. The second mixer 330-2 can be configured to frequency convert the second RF diversity signal using the common LO signal. The output of the second mixer 330-2 is coupled to a first variable phase shifter 362-1.

The output of the first variable phase shifter 362-1 is coupled to an input of a second combiner 370-2 as well as to an input of a second filter 340-2. The second filter 340-2 operates to filter the second diversity signal, and couples the filtered second diversity signal to a second input of the first correlator 350-1.

The first correlator 350-1 correlates the first diversity signal to the second diversity signal, and generates a correlation value. The first correlator 350-1 outputs the correlation value to a first loop filter 360-1. The first loop filter filters the correlation value and couples the filtered value to a control input of the first variable phase shifter 362-1 to adjust the phase shift based in part on the correlation value.

The diversity receiver 300 may include one or more other diversity paths implemented in a similar manner, with diversity paths paired for the purposes of correlating their diversity signals. For example, an Nth antenna 302-N can be coupled to an analog front end and then to a correlator 354-2 for correlation with another diversity signal and combining with the other diversity signals from other diversity paths.

All of the combiners 370 can be configured to combine the diversity signals to a signal output. For example, the output of the second combiner 370-2 can be provided as an input to the first combiner 370-1 to enable the first combiner 370-1 to output a single combined signal.

The combined signal from the first combiner 370-1 can be coupled to one or more modules or elements for additional processing. For example, the output from the first combiner 370-1 can be coupled to a low pass filter 380. The output of the low pass filter 380 can be coupled to an analog to digital converter (ADC) 390 that operates to convert the analog signal to a digital representation. The ADC 390 can be coupled to a demodulator 394 or other baseband processor.

The correlator 350-1 can perform correlation either in the analog domain or the digital domain. The correlator 350-1 shown connected to the diversity paths operates in the analog domain, while the alternative embodiment of the correlator 350-1 operates to correlate the signals in the digital domain.

In the analog correlator 350-1, the first diversity signal at the first input is coupled to a first variable gain amplifier 352-1 and from the output of the variable gain amplifier 352-1 to a first input of a multiplier 354-1. Similarly, the second diversity signal at the second input is coupled to a second variable gain amplifier 352-2 and from the output of the second variable gain amplifier 352-2 to a second input of the multiplier 354-1.

The multiplier 354-1 can determine a correlation value by multiplying the first diversity signal with the second diversity signal. The multiplier 354-1 can be configured, for example, as a multiplier, mixer, frequency discriminator, phase discriminator, and the like or some combination thereof or some other apparatus for correlating the signals.

In the alternative digital correlator 350-1 embodiment, the first diversity signal at the first input is coupled to a first variable gain amplifier 352-1 and from the output of the variable gain amplifier 352-1 to a first analog to digital converter 354-1. The digitized signals are coupled to a first input of a multiplier 354-1. Similarly, the second diversity signal at the second input is coupled to a second variable gain amplifier 352-2 and from the output of the second variable gain amplifier 352-2 to a second analog to digital converter 354-2. The second digitized output is coupled to a second input of the multiplier 354-1. The multiplier 354-1 operates in the digital domain to determine the correlation value. The multiplier 354-1 can be, for example, a hardware multiplier, a discriminator, or some other digital hardware for determining a correlation or combination of hardware.

FIG. 3B is a simplified functional block diagram of another embodiment of a diversity receiver 300. The operation of the diversity receiver 300 through the combiners is identical to that of the embodiment of FIG. 3A, and is not repeated for the sake of brevity.

The differences between the diversity receiver 300 embodiments of FIGS. 3A and 3B occur at the output of the first combiner 370-1. In the diversity receiver 300 embodiment of FIG. 3B, the output of the first combiner 370-1 is coupled to a low pass filter 380. The output of the low pass filter 380 is coupled to a frequency translator, here depicted as an IF mixer 382. The IF mixer 382 operates with a second LO (not shown) to upconvert the baseband signal to an intermediate frequency. The IF mixer 382 can also be configured to generate an aggregate signal representation from complex I and Q signal paths that may be output from the low pass filter 380.

The output of the IF mixer 382 can be coupled to one or more additional processing stages. For example, the output of the IF mixer 382 is coupled to a filter 384 that can be configured to remove undesired mixer signal components, and from the filter 384 to a variable gain amplifier 386.

The diversity receiver 300 embodiments described herein implement an optimal combining receiver which performs the combining prior to baseband and demodulator processing. The receiver as illustrated is a direct conversion receiver, but the techniques described here are applicable to low-IF or heterodyne receivers. The signal path MX1, S1, LPFS1 and following blocks are typically complex (I/Q) signal paths but are shown as a single path for the purposes of illustration simplicity.

Signals are received from each antenna by analog front ends AFᵢ where the subscript i indexes the diversity branch. In one embodiment, the diversity receiver combines the signals in the analog domain in baseband by estimating the phase shifts for each diversity path using a correlator (Cᵢⱼ where subscripts index the diversity branches being correlated), which can be implemented using hardware. The implementation of this correlator can be in digital or analog domain. The filters LPFDi can be followed by analog-to-digital converters which digitize the narrow-band signal prior to correlation.

In the embodiments shown in FIGS. 3A and 3B, each diversity path is correlated to an adjacent diversity path. Such an embodiment may be advantageous where one or more of the diversity paths may experience a signal fade or interference, which limits its ability to achieve strong correlation with other diversity paths. Of course, other configurations of correlation pairs may be implemented, and the actual pairing of diversity paths for correlation is not a limitation on the operation of the disclosed apparatus and methods for implementing a diversity receiver. In another embodiment, each diversity path may correlate to a first diversity path, which operates as a reference path. This embodiment can be advantageous because it limits a cumulative error that may result from correlating two diversity paths, where one of the diversity paths may be varied based on a correlation to a third diversity path. However, the single reference path embodiment may not provide a maximum combined signal if the reference path experiences a signal fade.

A correlator 350-1 is used to correlate two signal paths so that the signal paths can be cophased, combined using MRC or combined to optimize a signal quality metric.

The output of the correlator 350-1 is coupled to a loop filter, LF1, which provides a feedback signal to a phase shift network or module positioned in one of the signal paths. The bandwidth of the loop filter 360-1 can be adjusted or otherwise selected to determine a speed of the feedback loop. The loop filter, LF1, can be implemented as an analog filter or a combination of analog and digital filtering. The analog filter can be used at least for the purposes of anti-aliasing a digital signal from the correlator. The loop filter 360-1 can also include one or more digital filters to shape the feedback signal, or the digital filtering can be implemented as part of a digital correlator implementation. Where the output of the correlator 350-1 is a digital signal, DACs (not shown) can be used to convert the correlator output to an analog representation. Thus configured, the output of the correlator 350-1 can be used in a diversity feedback loop to directly control the phase shifter, maximizing the correlation between each branch.

The phase shifting of I and Q component signals can be accomplished by applying complex gains in each component signal. The gains within each signal component can be implemented in hardware in order to cover a wide range of phases.

The signals coupled to the correlator inputs can be further filtered to reduce noise and interference sources. A bandpass filter can used in each diversity path to filter the signal provided to the correlator input. Bandpass filters LPFDᵢ 352-1, 352-2, can be configured as relatively narrow-bandwidth filters which reject all signals except a portion of the desired signal. For example, the bandpass filters 352-1, 352-2, can be used to couple a portion of the received signal band that is unlikely to experience co-channel interference. A received signal can have a signal bandwidth or desired bandwidth that is on the order of 6 MHz.

The bandpass filter 352-1, 352-2, in line with the correlator input can be configured with a bandwidth that is substantially narrower than the desired bandwidth. For example, the bandwidth of the bandpass filter may be on the order of ¾, ½, ⅓, ⅕ or some other fractional portion of the desired bandwidth. For example, the bandpass filter 352-1, 352-2, in line with the correlator input can have a passband of approximately 200 kHz and can be centered in the receive signal band. The position of the center frequency of each bandpass filter 352-1, 352-2, need not be in the center of the band of the diversity signal, but can be positioned anywhere within the signal band. Typically, the center of the desired signal band is largely devoid of co-channel interference.

Such a bandwidth is sufficient to achieve a good correlation signal for the feedback path and reduces coupling of noise and interferers to the correlators. Because these filters are narrow in bandwidth relative to the signal bandwidth and do not have stringent noise requirements, their size, complexity and power consumption are low. A small physical implementation can be particularly advantageous where the diversity receiver is implemented on an integrated circuit, where die space is at a premium and constraints on die area limit the complexity of the elements that can be implemented on the die. The filters can feed analog-to-digital converters ADCᵢ which allow the correlator to be implemented digitally using available DSP techniques.

The resulting combined signal from combiner S1 is filtered by LPFS1 and digitized by ADC before being sent to the demodulator. In another embodiment, the combiners Sᵢ can be implemented digitally by performing digitizing beforehand.

One of the advantages of this approach to diversity is that it can accommodate a wide range of demodulators and standards without requiring significant modification of the demodulator algorithms, thereby allowing the technique to be applied to a range of standards in a straightforward manner.

Each of the diversity branches can be configured to operate with its own AGC loop. Signal strength information is typically available for each branch and can be used to weight each diversity branch appropriately. A simple algorithm would be to weight each branch proportional to the signal strength or signal quality of that branch. This would prevent branches with poor signal strength from degrading the combined signal. In another embodiment, each diversity branch can be amplitude equalized using the variable gain amplifiers.

Further performance enhancements can be obtained by taking advantage of time-sliced protocols, where a receiver is allocated a particular time slot and is typically not active during times other than the desired (active) time slot.

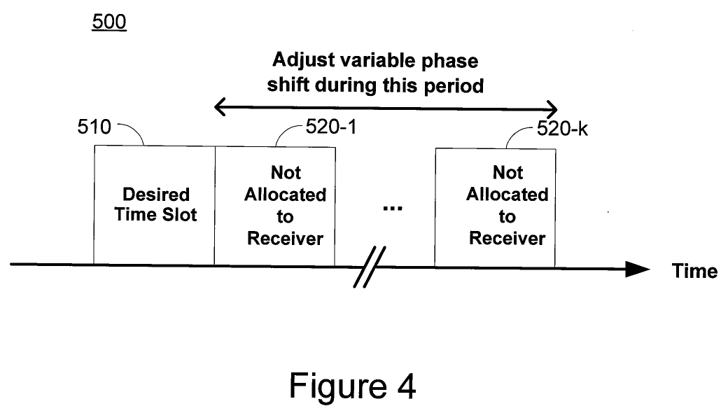

FIG. 4 is a simplified timing diagram 500 of an embodiment of a time division multiple access (TDMA) timing and utilizing time-sliced protocols to improve estimation of phase shifter settings. The TDMA timing diagram 500 illustrates a first time slot 510 that can be assigned or otherwise associated with the diversity receiver. The TDMA timing diagram 500 illustrates additional time slots 520-1 through 520-k that are not assigned or otherwise associated with the diversity receiver. The diversity receiver may be inactive during unassigned time slots 520-1 through 520-k.

During inactive periods or slots, individual branches of the diversity receiver can be selectively made active, and the resultant signal can be demodulated in baseband in order to improve the estimation of the settings for phase shifters PSNᵢ in order to improve the carrier to noise and interference ratio. For example, the following techniques can be implemented jointly or individually:

During unused time slices, the diversity receiver can estimate a first-order phase tilt or a more complex equalizing method across each channel and compensate for this with baseband analog circuits prior to combining signals. The implementation complexity of this can be adjusted as desired for each application.

During unused time slices, the diversity receiver can estimate the signal quality of each branch to permit optimal combining of the two branches by weighting each branch according to a signal quality metric.

This diversity system is also amenable to use in conjunction with selection diversity in cases where the quality of the signal from one branch is extremely poor, as may be the case when the signal entering one of the branches has been corrupted by interferers. The receiver can use time slices or symbol boundaries to switch among branches to assess the signal quality of each branch before deciding whether to use correlation and combining or to use selection diversity. In the case that selection diversity is desired, the receiver simply shuts off the branch or branches with poor signal quality. The selection can be implemented, for example, at each of the combiners.

Features of the apparatus and methods for diversity combining a received signal include a shared synthesizer and LO drive for mixers MX_{IQi}; a shared baseband channel filtering, amplifiers and data conversion circuits; baseband phase shifting with complex phase shifters PSNᵢ; low-complexity estimation of phase shifter settings using correlators.

Band limiting the correlator signals using the narrow bandpass filters NBPFᵢ, can be used to reduce or eliminate the effects of interference, such as co-channel interference. The diversity receiver may also enable combining of all signals in analog domain prior to channel selection filtering in the signal path SP1. The signal combiners can operate to weighting each diversity branch by a metric (such as the inverse of signal strength) prior to combining.

The diversity receiver may implement improved estimation of the phase shifter settings using inactive slots of a time-sliced protocol, and may be configured to improve combining though first-order phase tilt correction.

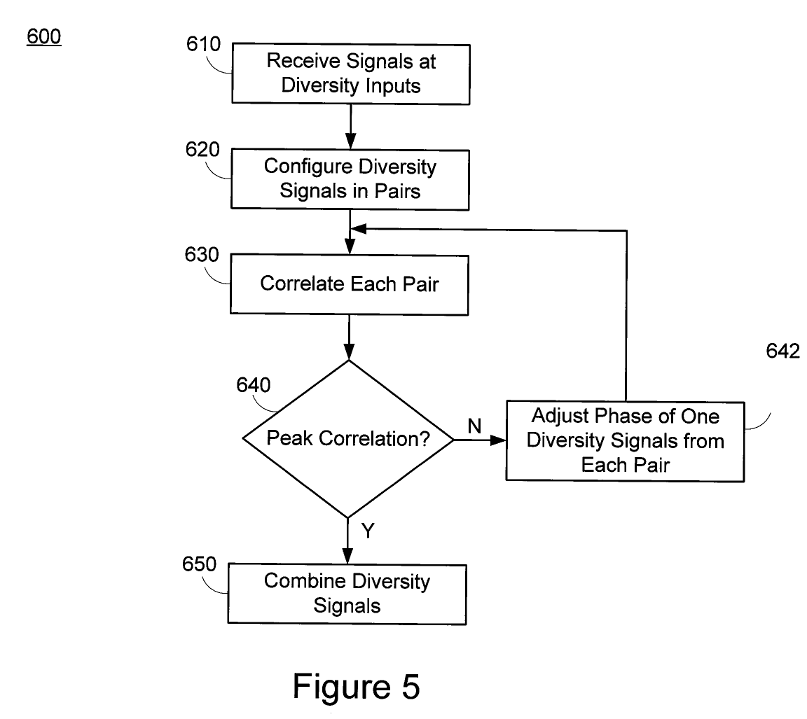

FIG. 5 is a simplified flowchart of an embodiment of a method 600 of diversity combining signal sin a diversity receiver. The method 600 can be implemented, for example, by any one of the diversity receiver embodiments of FIGS. 2A-2B, and 3A-3B.

The method 600 begins at block 610 where the diversity receiver receives signals at the multiple diversity inputs. Although the diversity receiver embodiments are described in conjunction with distinct antennas, such an implementation is not a requirement for the receipt of diversity signals.

The diversity receiver proceeds to block 620 and configures the diversity signals in pairs. This step may be implicit within the hardware configuration of the diversity receiver, but may also be performed dynamically.

The diversity receiver proceeds to block 630 and correlates each pair of diversity signals. The diversity receiver can utilize, for example, a mixer, multiplier, or discriminator to perform the correlation.

The diversity receiver proceeds to decision block 640 to determine if the correlation is at a peak. If not at a correlation peak, the diversity receiver proceeds to block 642 and adjusts the phase of one of the diversity signals in the diversity signal pair. The diversity receiver then returns to block 630 to update the correlation.

If, at decision block 640 the diversity receiver determines that the correlation is at a peak, the diversity receiver proceeds to block 650 and combines the diversity signal paths. The diversity receiver can combine the signal paths by summing all of the diversity signal paths, selectively summing some of the diversity signal paths, or selecting one or more of the diversity signals.

The diversity receiver can be configured to optimize the phase and correlation of the diversity pairs in parallel or in series. Thus, in some embodiments, the diversity receiver can be configured to serially optimize the correlation of diversity signal pairs.

Apparatus and methods of diversity combining of received signals are described herein. Diversity combining of distinct receive paths can be performed in the analog domain by correlating two or more of the diversity paths and combining prior to baseband processing. The correlated signals may only be portions of the desired receive signal. Phase compensation of diversity paths can be achieved through rotation of the signal.

Any of various diversity techniques may be implemented. for example, the gains and phases for each of the diversity path can be equalized prior to combination. Alternatively, the phases of the diversity paths may be equalized, but the amplitudes may be weighted based on a receive signal strength corresponding to the particular path.

Phase and amplitude balance may be further optimized in a TDM system by optimizing the correlations, and thus the phase shifts, during time slots not allocated to the receiver.

As used herein, the term coupled or connected is used to mean an indirect coupling as well as a direct coupling or connection. Where two or more blocks, modules, devices, or apparatus are coupled, there may be one or more intervening blocks between the two coupled blocks.

The various illustrative logical blocks, modules, and circuits described in connection with the embodiments disclosed herein may be implemented or performed with a general purpose processor, a digital signal processor (DSP), a Reduced Instruction Set Computer (RISC) processor, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of combining signals in a diversity receiver, the method comprising:
receiving an RF signal in each of a plurality of diversity signal paths;
frequency converting each of the RF signals to a corresponding frequency converted diversity signal;
correlating a first frequency converted diversity signal with at least one distinct frequency converted diversity signal to generate a correlation value;
adjusting a phase of the first frequency converted diversity signal based on the correlation value; and
combining the frequency converted diversity signals.

2. The method of claim 1, further comprising frequency converting the combined frequency converted diversity signal to an Intermediate Frequency.

3. The method of claim 1, further comprising demodulating the combined frequency converted diversity signal.

4. The method of claim 1, wherein receiving the RF signal comprises receiving a Time Division Multiple Access (TDMA) signal during at least one time slot not assigned to the diversity receiver.

5. The method of claim 1, wherein frequency converting each of the RF signals comprises mixing each of the RF signals with a common Local Oscillator signal to generate substantially a baseband signal.

6. The method of claim 1, wherein frequency converting each of the RF signals comprises mixing each of the RF signals with a quadrature Local Oscillator to generate quadrature signals.

7. The method of claim 1, wherein correlating the first frequency converted diversity signal with at least one distinct frequency converted diversity signal comprises multiplying the first frequency converted diversity signal with the at least one distinct frequency converted diversity signal.

8. The method of claim 7, wherein correlating the first frequency converted diversity signal with at least one distinct frequency converted diversity signal further comprises filtering each of the first frequency converted signal and the at least one distinct frequency converted diversity signal to a bandwidth narrower than a desired signal bandwidth prior to multiplying.

9. The method of claim 1, wherein combining the frequency converted diversity signals comprises selecting one frequency converted diversity signal.

10. The method of claim 1, wherein combining the frequency converted diversity signals comprises selectively summing at least two of the frequency converted diversity signals.

11. A method of combining signals in a diversity receiver, the method comprising:
receiving a first RF signal;
frequency converting the first RF signal to a first diversity signal;
receiving a second RF signal;
frequency converting the second RF signal to a second diversity signal;
phase shifting the second diversity signal to generate a phase shifted diversity signal;
correlating the first diversity signal with the phase shifted diversity signal to determine a correlation value;
adjusting a phase shift of the phase shifted diversity signal based on the correlation value; and
summing the first diversity signal with the phase shifted diversity signal to generate a combined signal.

12. The method of claim 11, further comprising frequency converting the combined signal to an Intermediate Frequency.

13. The method of claim 11, wherein correlating the first diversity signal with the phase shifted diversity signal comprises:
filtering the first diversity signal to a bandwidth that is less than approximately one-half of a desired signal bandwidth to generate a filtered diversity signal; and
multiplying the filtered diversity signal with the phase shifted diversity signal.

14. The method of claim 13, wherein filtering the first diversity signal comprises filtering the first diversity signal to generate the filtered diversity signal from a portion of the desired signal bandwidth that is typically devoid of co-channel interference.

15. The method of claim 11, wherein the first RF signal comprises an Orthogonal Frequency Division Multiplex (OFDM) signal.

16. A diversity receiver, comprising:
a first RF front end configured to receive a first RF signal and frequency convert the first RF signal and output a first diversity signal;
a second RF front end configured to receive a second RF signal and frequency convert the second RF signal and output a second diversity signal;
a variable phase shifter coupled to the second RF front end and configured to selectively phase shift the second diversity signal to generate a phase shifted second diversity signal based on a value at a control input;
a correlator having a first input coupled to the first RF front end, a second input coupled to an output of the variable phase shifter, and configured to determine a correlation value based at least in part on the first diversity signal and the phase shifted second diversity signal and couple the correlation value to the control input of the variable phase shifter; and
a combiner coupled to the first RF front end and the variable phase shifter and configured to combine the first diversity signal with the phase shifted second diversity signal.

17. The diversity receiver of claim 16, wherein the correlator comprises:
a first filter coupled to the first input and configured to filter the first diversity signal;
a second filter coupled to the second input and configured to filter the phase shifted second diversity signal; and
a multiplier having a first input coupled to the first filter and a second input coupled to the second filter and configured to multiply a filtered first diversity signal with a filtered phase shifted second diversity signal.

18. The diversity receiver of claim 17, wherein at least one of the first or second filter is configured to have a passband that is less than approximately one-half a signal bandwidth of the first diversity signal or the phase shifted second diversity signal, respectively.

19. The diversity receiver of claim 17, wherein the multiplier comprises a mixer.

20. The diversity receiver of claim 16, further comprising a loop filter having an input coupled to an output of the correlator and an output coupled to the control input of the variable phase shifter.

21. The diversity receiver of claim 16, further comprising a frequency converter coupled to the combiner and configured to frequency convert a combined signal from the combiner to an Intermediate Frequency.

22. The diversity receiver of claim 16, further comprising:
a third RF front end configured to receive a third RF signal and frequency convert the third RF signal and output a third diversity signal;
an additional variable phase shifter coupled to the third RF front end and configured to selectively phase shift the third diversity signal to generate a phase shifted third diversity signal based on a value at a control input;
an additional correlator having a first input coupled to the output of the variable phase shifter, a second input coupled to an output of the additional variable phase shifter, and configured to determine an additional correlation value based at least in part on the phase shifted second diversity signal and the phase shifted third diversity signal and couple the additional correlation value to the control input of the additional variable phase shifter, and
wherein the combiner is further coupled to the output of the additional variable phase shifter and is configured to combine the first diversity signal and the phase shifted second diversity signal with the third phase shifted diversity signal.

23. A diversity receiver, comprising:
means for receiving an RF signal in each of a plurality of diversity signal paths;
means for frequency converting each of the RF signals to a corresponding frequency converted diversity signal;
means for correlating a pair of frequency converted diversity signals to generate a correlation value;
means for adjusting a phase of one of the pair of frequency converted diversity signals based on the correlation value; and
means for combining the frequency converted diversity signals.
